(19) United States
(12) Patent Application Publication
(10) Pub. No.: US 2002/0169879 A1
(43) Pub. Date: Nov. 14, 2002

(54) Method and apparatus for firewall-evading stealth protocol

(76) Inventor: Kobus Jooste, Pretoria (ZA)

Correspondence Address: Glenn E. Von Tersch, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/132,034

(22) Filed: Apr. 24, 2002

Related U.S. Application Data
(60) Provisional application No. 60/290,317, filed on May 10, 2001.

(51) Int. Cl. G06F 15/16

(52) U.S. Cl. 709/227

(57) ABSTRACT

In one embodiment, the present invention is a method. The method includes calling a server through a firewall to allow the server to initiate communications. The method further includes receiving a first message responsive to calling the server, the first message being rejectable by the firewall if not responsive to calling the server. The method may further include determining that a second message should follow the first message. The method may also include calling the server through the firewall again. Moreover, the method may further include receiving the second message from the server responsive to calling the server again, the second message rejectable by the firewall if not responsive to calling the server again.

In an alternate embodiment, the present invention is also a method. The method includes receiving a request for connection at a server, and responding to the request with a message, the message initiating communication with a client through a firewall, the message passed through the firewall as responsive to the request, the message rejectable by the firewall if not responsive to the request. The method may also include further responding to the request with a second message, the second message passed through the firewall as responsive to the request, the second message rejectable by the firewall if not responsive to the request. The method may alternatively include receiving a second request from the client, and responding to the request with a second message, the second message passed through the firewall as responsive to the second request, the second message rejectable by the firewall if not responsive to the second request.

### BACKGROUND OF THE INVENTION

1. Field of the Invention

This invention generally relates to network communications as implemented on computers and more specifically relates to communications through firewalls.

2. Description of the Related Art

Previously, network communications essentially involved trusted links, such that any packet received was reliably received from an authorized sender. With the advent of the internet and public networks, packets received through a network connection could not be guaranteed to be safe. As a result, firewalls and other security measures were implemented. Such security could ensure that the packets received were appropriate, but restricted communications protocols. For example, unsolicited packets were generally rejected, even though some of those unsolicited packets might come from what should be a trusted source. Therefore, it would be advantageous to allow for relatively spontaneous communications through a firewall.

### SUMMARY OF THE INVENTION

In one embodiment, the present invention is a method. The method includes calling a server through a firewall to allow the server to initiate communications. The method further includes receiving a first message responsive to calling the server, the first message being rejectable by the firewall if not responsive to calling the server. The method may further include determining that a second message should follow the first message. The method may also include calling the server through the firewall again. Moreover, the method may further include receiving the second message from the server responsive to calling the server again, the second message rejectable by the firewall if not responsive to calling the server again.

In an alternate embodiment, the present invention is also a method. The method includes receiving a request for connection at a server, and responding to the request with a message, the message initiating communication with a client through a firewall, the message passed through the firewall as responsive to the request, the message rejectable by the firewall if not responsive to the request. The method may also include further responding to the request with a second message, the second message passed through the firewall as responsive to the request, the second message rejectable by the firewall if not responsive to the request. The method may alternatively include receiving a second request from the client, and responding to the request with a second message, the second message passed through the firewall as responsive to the second request, the second message rejectable by the firewall if not responsive to the second request.

### BRIEF DESCRIPTION OF THE DRAWINGS

The present invention is illustrated by way of example and not limitation in the accompanying figures.

FIG. 1 illustrates an embodiment of a system.

FIG. 2 illustrates an alternate embodiment of a system.

FIG. 3 provides a flow diagram illustrating an embodiment of a process.

FIG. 4 provides a flow diagram illustrating an alternate embodiment of a process.

FIG. 5 illustrates a machine which may be used as a system or part of a system.

### DETAILED DESCRIPTION

A method and apparatus for a firewall-evading stealth protocol is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In one embodiment, the present invention is a method. The method includes calling a server through a firewall to allow the server to initiate communications. The method further includes receiving a first message responsive to calling the server, the first message being rejectable by the firewall if not responsive to calling the server. The method may further include determining that a second message should follow the first message. The method may also include calling the server through the firewall again. Moreover, the method may further include receiving the second message from the server responsive to calling the server again, the second message rejectable by the firewall if not responsive to calling the server again.

In an alternate embodiment, the present invention is also a method. The method includes receiving a request for connection at a server, and responding to the request with a message, the message initiating communication with a client through a firewall, the message passed through the firewall as responsive to the request, the message rejectable by the firewall if not responsive to the request. The method may also include further responding to the request with a second message, the second message passed through the firewall as responsive to the request, the second message rejectable by the firewall if not responsive to the request. The method may alternatively include receiving a second request from the client, and responding to the request with a second message, the second message passed through the firewall as responsive to the second request, the second message rejectable by the firewall if not responsive to the second request.

In one embodiment, a client PC is served by a service which accesses the client PC for purposes of updating its software, repairing the PC, or otherwise providing services related to the client PC. However, as the client PC is isolated from the service hardware by a firewall, no unsolicited connections may be made. Instead, the client PC sends a request to the service hardware, and the service hardware responds to the request (with a solicited packet), to either determine what needs to be done or take scheduled or appropriate action. As will be appreciated, this process may be repeated and may be varied.

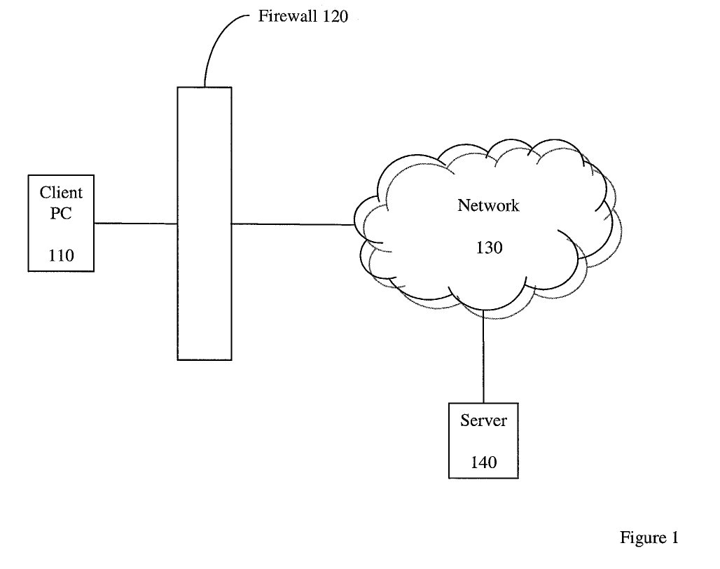

FIG. 1 illustrates an embodiment of a system. Client PC 110 is coupled to a firewall 120, which may be coupled to a network 130. Network 130 may be a public network such as the internet or other public networks, or may also be a private network. Server 140 is also coupled to network 130, allowing for a communication path between client PC 110 and server 140 when all of the couplings are in place, or for a coupling between client PC 110 and server 140.

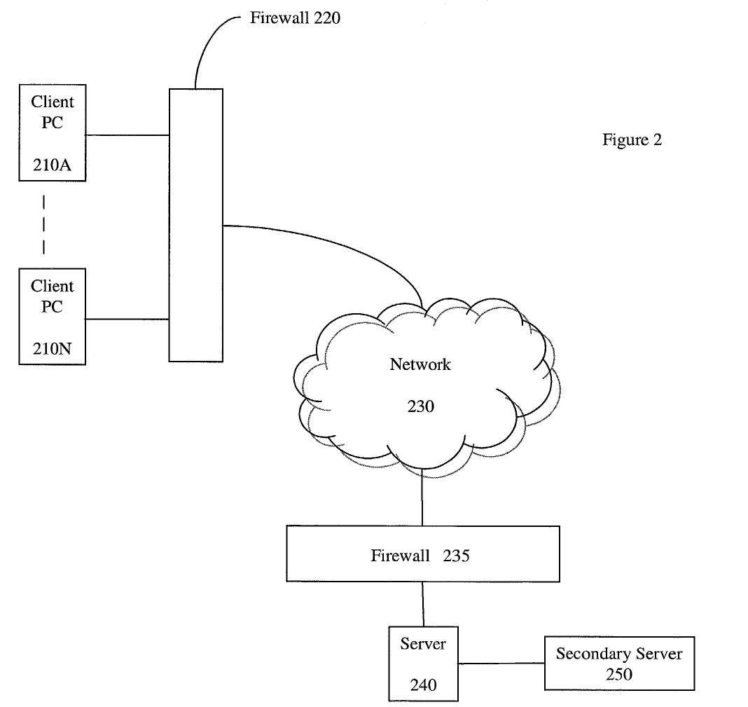

FIG. 2 illustrates an alternate embodiment of a system. Client PC 210A and other client PCs including client PC 210N are all coupled to firewall 220. Firewall 220 is coupled to a network 230, such as the internet. Network 230 is coupled to second firewall 235, and second firewall 235 is coupled to server 240. Server 240 is in turn coupled to secondary server 250. Note that requests to the server 240 through second firewall 235 may be of a nature which appears to be unsolicited, but which are related to serving webpages or other known functions of the server, and thus are allowed.

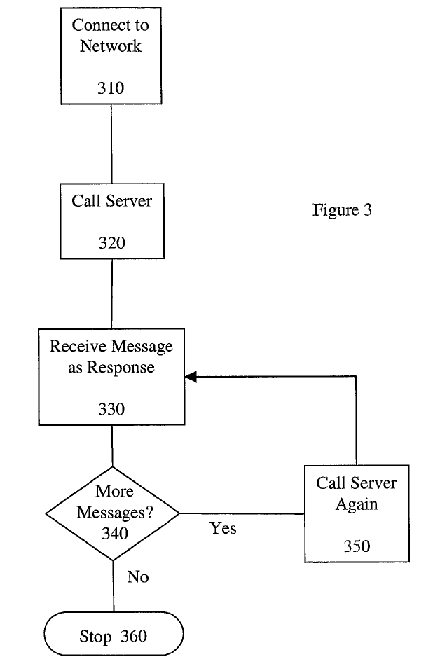

FIG. 3 provides a flow diagram illustrating an embodiment of a process. At block 310, a client connects to the network, such as a client PC connecting to the internet through a firewall. At block 320, the client PC calls a server which provides an interface for services or web pages. Such a call may take the form of logging on to a system for example, or requesting a predetermined web address using HTTP or other similar protocols. At block 330, a message is received by the client PC as a response to the call of block 320. The responsive message may take the form of a packet of data for example, and may provide indications of various types. For example, the responsive message may indicate that more messages are coming, may provide data directly responsive to the request, or may provide data indirectly responsive to the request.

At block 340, a determination is made as to whether the responsive message of block 330 indicated that more messages were to be sent. If more messages were to be sent, then at block 350, the client PC calls the server again, with the expectation of receiving the next in what may be a series of messages. The process then moves to block 330 for another responsive message. If no more messages are to be sent, the process terminates at block 360.

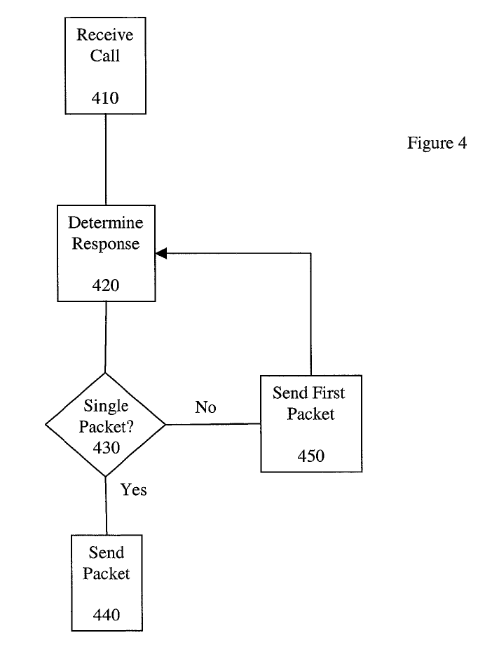

FIG. 4 provides a flow diagram illustrating an alternate embodiment of a process. At block 410, a server receives a call or request. At block 420, the server determines what the response should be. In one embodiment, the calls are related to an over-the-internet process for maintaining and upgrading software, while in other embodiments the calls may be related to other distributed processes or methods. After the response is determined, at block 430, a determination is made as to whether the response fits in a single packet. If so, the packet is sent at block 440, and the process ends. If the response requires multiple packets, the first packet of a potential series of packets is sent at block 450, and the process then returns to block 410 to await a call for the next packet in the series.

Note that the processes of FIGS. 3 and 4, when carried out using a store-and-forward network, may take advantage of the nature of the network to cause packets to be stored even though a machine on one or the other end of the process is not continuously connected to the network. For example, a packet may indicate how many more packets are coming, causing a receiving machine to request each packet of the series before going offline. The responsive packets of the series may then be stored by the network until the receiving machine reconnects, thus allowing the receiving machine to receive the series of packets without continuous effort and monitoring from the server. Furthermore, it will be appreciated that a call to a server may result in multiple received packets, causing the intervening firewall to accept all of the packets.

As previously described, in one embodiment, this process may be initiating a transaction from a client, and completing the transaction from the server by sending a message, or completing a portion of the transaction from the server by sending a message which indicates more messages will follow. In one embodiment, these messages are packets of data sent over a network such as the internet, and these packets may be physical packets or logical packets composed of one or more physical packets.

Moreover, these messages may be sent using a variety of methods, protocols, and corresponding hardware or systems and media. For example, these messages may be sent using HTTP (hyper-text transmission protocol) over the internet.

The messages may include parameterized data, XML, binary large objects (BLOBs) or other data. In one embodiment, the protocol for communicating in the messages is effectively layered over the HTTP, allowing the underlying HTTP to be processed by the network, and allowing the machines (server and client for example) to further process the messages to discern the contents therein. Thus, PORT 80 and HTTP may be utilized to send messages through a firewall which would be rejected if the messages were sent to the client through the firewall without a request. The request creates the path through the firewall, by indicating what the message is responsive to, and thereby indicating the message is not unsolicited.

In one embodiment, the client acts by receiving a request to send to a server (such as from an application), parameterizing the request, and sending the request using HTTP to the server. The server then translates the request to a web-application server, and a web-application server running a servlet parses the data and sends response. The server then receives the response and sends that to the client as a response to the request. The developer writing software for either end of this transaction may use a communications protocol without worrying about the underlying details of the HTTP transmission, and without worrying about the intervening firewall(s). Furthermore, the communications protocol from the developer's point of view may accept all of the data responsive to the request, with the underlying software layer breaking the data down into manageable packets.

As will be appreciated, other features of the protocol may be implemented, such as in some form of helper library. For example, a message kill feature may be implemented, allowing either a client or server to either kill a specific message (terminating processing on it) or to kill a connection. Additionally, messages may be sent using XML, using known XML generators and parsers for example, thus allowing the communications protocol to send and receive XML data, but also requiring the communications protocol to support XML data in addition to parameterized data. In one embodiment, XML data is sent by using an HTTP header and a body composed of XML data in a packet. A function may be used to interpret data of various formats on the receiving end based on known or shared protocols for encoding XML or parameterized data for example. Similarly, BLOBs may be communicated with an HTTP header and a portion of BLOB data, along with an indication that more BLOB data follows to complete the BLOB.

Note that the indication of a stream of packets may be implemented as part of the HTTP header or as some other similar portion of the packet which indicates that more packets are to follow, and potentially how many more packets.

Note that in one embodiment, the protocol is used for provision of service to machines at a client site. The machines are leased by the client, and periodically log on to the servers. When the machines are logged on, problems may be diagnosed remotely, software may be updated, reconfigured or otherwise changed (added or deleted among other things), and other services may be performed. The leased machines may be behind a firewall, but may use the protocol in question as long as it is possible to access a web page through the firewall for example. Thus, a patch-checker may be employed to check for (new) patches to application software, download the patches, and install them into the client machine software for example. This may result in some form of software maintenance fees in a lease agreement for example, or some other form of remittance for the services in question.

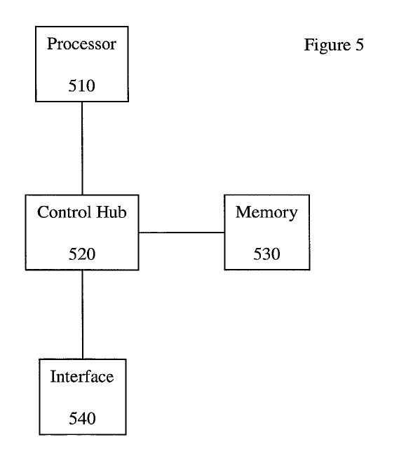

FIG. 5 illustrates a machine which may be used as a system or part of a system. Processor 510 is coupled to control hub 520. Control hub 520 is in turn coupled to memory 530 and interface 540. Interface 540 may include a connection to a network and may also include connections to input and output devices for use by users, such as mice, keyboards, touch pads, monitors, speakers, or other devices. Memory 530 may be made of a variety of different media, such as those listed later in this document. Processor 510 may be made to execute instructions, which may be embodied in memory 530 for example, and may cause processor 510 to execute a method, potentially in conjunction with some or all of control hub 520, memory 530, and interface 540.

Some portions of the detailed description are presented in terms of algorithms and symbolic representations of operations on data bits within a computer memory. These algorithmic descriptions and representations are the means used by those skilled in the art to most effectively convey the substance of their work to others skilled in the art. An algorithm as described here is generally conceived to be a self consistent sequence of acts or operations leading to a desired result. The acts are those requiring physical manipulations of physical quantities. Usually, though not necessarily, these quantities take the form of electrical or magnetic signals capable of being stored, transferred, combined, compared and otherwise manipulated. It has proven convenient at times principally for reasons of common usage to refer to these signals as bits, values, elements, symbols, characters, terms, numbers, data or the like.

It should be borne in mind, however, that all of these in similar terms are to be associated with the appropriate physical quantities and are merely convenient labels applied to these quantities. Unless specifically stated otherwise as apparent from the following discussion it is appreciated that throughout the description discussions utilizing terms such as “processing” or “computing” or “calculating” or “determining” or “displaying” or the like refer to the action and processes of a computer system or similar electronic computing device that manipulates and transforms data represented as physical (electronic) quantities within the computer systems registers and memories into other data similarly represented as physical quantities within the computer system memories or registers or other such information storage transmission or display devices. The present invention can be implemented by an apparatus for performing the operations herein. This apparatus may be specially constructed for the required purposes or it may comprise a machine such as a general purpose computer selectively activated or reconfigured by a computer program stored in the computer. Such a computer program may be stored in a computer readable storage medium such as but not limited to any type of disk including floppy disks, optical disks, CD roms and magnetic optical disks, read only memories, random access memories, EPROMS, EEPROMS, magnetic or optical cards or any type of media suitable for storing electronic constructions and each coupled to a computer system bus. Each of these media may be coupled to a computer system bus through use of an appropriate device for reading and or writing the media in question. Specialty apparatus may include a collection of readily available pieces or an application specific integrated circuit including a series of logic blocks for example.

The algorithms and displays presented herein are not inherently related to any particular computer or other apparatus. Various general purpose systems may be used with programs in accordance with the teachings herein or it may prove convenient to construct more specialized apparatus to perform the required method. For example, any of the methods according to the present invention can be implemented in hard wired circuitry by programming a general purpose processor or by any combination of hardware and software. One of skill in the art will immediately appreciate that the invention can be practiced with computer system configuration. Configurations other than those described below including hand held devices, multi processor systems, microprocessor based or programmable consumer electronics, network PCs, mini computers, main frame computers and the like. The invention may also be practiced in distributed computing environments or tasks or performed by remote processing devices that are linked through a communications network. The required structure for a variety of these systems will appear from the description below.

The methods of the invention may be implemented using computer software. If written in a programming language conforming to a recognized standard sequences of instructions designed to implement the methods can be compiled for execution on a variety of hardware platforms or machines and for interface to a variety of operating systems. In addition the present invention is not described with reference to any particular programming language. It will be appreciated that a variety of programming languages may be used to implement the teachings of invention as described herein. Furthermore, it is common in the art to speak of software in one form or another (for example program procedure application etc . . . ) as taken in action or causing a result. Such expressions are merely a shorthand way of saying that execution of the software by a computer causes the processor of the computer to perform an action or produce a result.

In the foregoing detailed description, the method and apparatus of the present invention has been described with reference to specific exemplary embodiments thereof. It will, however, be evident that various modifications and changes may be made thereto without departing from the broader spirit and scope of the present invention. In particular, the separate blocks of the various block diagrams represent functional blocks of methods or apparatuses and are not necessarily indicative of physical or logical separations or of an order of operation inherent in the spirit and scope of the present invention. For example, the various blocks of FIG. 5 (for example) may be integrated into components, or may be subdivided into components. Similarly, the blocks of FIG. 3 (for example) represent portions of a method which, in some embodiments, may be reordered or may be organized in parallel rather than in a linear or step-wise fashion. The present specification and figures are accordingly to be regarded as illustrative rather than restrictive.

What is claimed is:

1. A method comprising:
calling a server through a firewall to allow the server to initiate communications; and
receiving a first message responsive to calling the server, the first message being rejectable by the firewall if not responsive to calling the server.

2. The method of claim 1 further comprising:
connecting to a network, the network connected to the firewall.

3. The method of claim 2 further comprising:
determining that a second message should follow the first message;
calling the server through the firewall again; and
receiving the second message from the server responsive to calling the server again, the second message rejectable by the firewall if not responsive to calling the server again.

4. The method of claim 1 wherein:
the first message includes information suitable for upgrading software on a host computer, the host computer performing the calling and receiving.

5. The method of claim 4 wherein:
the information includes at least one of the group of:
parameterized data, XML, or binary large objects.

6. The method of claim 5 wherein:
the first message includes a series of packets, each packet rejectable by the firewall if not responsive to calling the server.

7. The method of claim 3 wherein:
the first message is embodied as a first packet of a series of packets, the second message is embodied as a second packet of the series of packets.

8. A method comprising:
receiving a request for connection at a server; and
responding to the request with a message, the message initiating communication with a client through a firewall, the message passed through the firewall as responsive to the request, the message rejectable by the firewall if not responsive to the request.

9. The method of claim 8, further comprising:
further responding to the request with a second message, the second message passed through the firewall as responsive to the request, the second message rejectable by the firewall if not responsive to the request.

10. The method of claim 8, wherein:
the message includes an identifier corresponding to a following message; and further comprising:
receiving a second request from the client; and
responding to the request with a second message, the second message passed through the firewall as responsive to the second request, the second message rejectable by the firewall if not responsive to the second request.

11. The method of claim 8 wherein:
the message includes information suitable to upgrade software of the client.

12. The method of claim 11 wherein:
the request includes information identifying the client.

13. The method of claim 12 wherein:
the message includes at least one of the group of:
parameterized data, XML, or binary large objects.

14. The method of claim 8 wherein:
the message is embodied as a series of packets, each packet of the series of packets sent to the client through the firewall.

15. The method of claim 9 wherein:
the message is embodied as a first packet of a series of packets and the second message is embodied as a second packet of the series of packets.

16. The method of claim 10 wherein:
the message is embodied as a first packet of a series of packets and the second message is embodied as a second packet of the series of packets.

17. The method of claim 10 wherein:
the message is embodied as a series of packets, each packet of the series of packets sent to the client through the firewall.

18. A machine-readable medium embodying instructions which, when executed by a processor, cause the processor to perform a method, the method comprising:
calling a server through a firewall to allow the server to initiate communications; and
receiving a first message responsive to calling the server, the first message being rejectable by the firewall if not responsive to calling the server.

19. The machine-readable medium of claim 18, further embodying instructions which, when executed by a processor, cause the processor to perform a method further comprising:
connecting to a network, the network connected to the firewall.

20. The machine-readable medium of claim 18, further embodying instructions which, when executed by a processor, cause the processor to perform a method further comprising:
determining that a second message should follow the first message;
calling the server through the firewall again; and
receiving the second message from the server responsive to calling the server again, the second message rejectable by the firewall if not responsive to calling the server again.

21. The machine-readable medium of claim 18, further embodying instructions which, when executed by a processor, cause the processor to perform a method wherein:
the first message includes instructions suitable for execution by the processor, the instructions causing the processor to upgrade software on a host computer containing the processor.

22. The machine-readable medium of claim 18, further embodying instructions which, when executed by a processor, cause the processor to perform a method wherein:
the first message includes a series of packets, each packet rejectable by the firewall if not responsive to calling the server.

23. The machine-readable medium of claim 18, further embodying instructions which, when executed by a processor, cause the processor to perform a method wherein:
the first message is embodied as a first packet of a series of packets, the second message is embodied as a second packet of the series of packets.

24. A machine-readable medium embodying instructions which, when executed by a processor, cause the processor to perform a method, the method comprising:
receiving a request for connection at a server; and
responding to the request with a message, the message initiating communication with a client through a firewall, the message passed through the firewall as responsive to the request, the message rejectable by the firewall if not responsive to the request.

25. The machine-readable medium of claim 24, further embodying instructions which, when executed by a processor, cause the processor to perform a method further comprising:
further responding to the request with a second message, the second message passed through the firewall as responsive to the request, the second message rejectable by the firewall if not responsive to the request.

26. The machine-readable medium of claim 24, further embodying instructions which, when executed by a processor, cause the processor to perform a method further comprising:
the message includes an identifier corresponding to a following message; and further comprising:
receiving a second request from the client; and
responding to the request with a second message, the second message passed through the firewall as responsive to the second request, the second message rejectable by the firewall if not responsive to the second request.

27. The machine-readable medium of claim 24, further embodying instructions which, when executed by a processor, cause the processor to perform a method wherein:
the first message includes instructions suitable for execution by a second processor, the instructions to cause the second processor to upgrade software on a host computer containing the second processor.

28. The machine-readable medium of claim 24, further embodying instructions which, when executed by a processor, cause the processor to perform a method wherein:
the message is embodied as a series of packets, each packet of the series of packets sent to the client through the firewall.

29. The machine-readable medium of claim 26, further embodying instructions which, when executed by a processor, cause the processor to perform a method wherein:
the message is embodied as a first packet of a series of packets and the second message is embodied as a second packet of the series of packets.

30. An apparatus comprising:
means for calling a server through a firewall to allow the server to initiate communications; and
means for receiving a first message responsive to the means for calling, the first message being rejectable by the firewall if not responsive to the means for calling.

31. An apparatus comprising:
a processor;
a control hub coupled to the processor;
a memory coupled to the control hub;
an interface coupled to the control hub; and
wherein the processor is to:
call a server through the interface and through a firewall to allow the server to initiate communications; and
receive a first message responsive to calling the server through the interface and through the firewall, the first message being rejectable by the firewall if not responsive to calling the server.

32. The apparatus of claim 31 wherein the processor is further to:
connect to a network through the interface, the network connected to the firewall.

33. The apparatus of claim 31 wherein the processor is further to:
determine that a second message should follow the first message;
call the server through the interface and through the firewall again; and
receive the second message through the interface and through the firewall from the server responsive to calling the server again, the second message rejectable by the firewall if not responsive to calling the server again.

34. An apparatus comprising:
a processor;
a control hub coupled to the processor;
a memory coupled to the control hub;
an interface coupled to the control hub; and
wherein the processor is to:
receive a request for connection through the interface; and
responding to the request through the interface with a message, the message initiating communication with a client through a firewall, the message passed through the firewall as responsive to the request, the message rejectable by the firewall if not responsive to the request.

35. The apparatus of claim 34 wherein the processor is further to:
further respond to the request through the interface with a second message, the second message passed through the firewall as responsive to the request, the second message rejectable by the firewall if not responsive to the request.

36. The apparatus of claim 34 wherein:
the message includes an identifier corresponding to a following message; and
wherein the processor is further to:
receive a second request from the client through the interface; and
respond to the request through the interface with a second message, the second message passed through the firewall as responsive to the second request, the second message rejectable by the firewall if not responsive to the second request.
